(19) United States
(12) Patent Application Publication
(10) Pub. No.: US 2026/0259363 A1
(43) Pub. Date: Sep. 3, 2026

(54) WAVEGUIDE FOR DISPLAY PANEL

(71) Applicant: Applied Materials, Inc., Santa Clara, CA (US)

(72) Inventors: Yingnan LIU, Austin, TX (US); Samarth BHARGAVA, Saratoga, CA (US); Evan WANG, Palo Alto, CA (US); Kevin MESSER, Mountain View, CA (US); Kunal SHASTRI, Santa Clara, CA (US)

(21) Appl. No.: 19/489,218

(22) PCT Filed: May 29, 2024
(86) PCT No.: PCT/US2024/031350

§ 371 Date: Dec. 1, 2025

Related U.S. Application Data
(60) Provisional application No. 63/506,257, filed on Jun. 5, 2023.

(51) Int. Cl. F21V 8/00; G02B 1/11; G02B 5/18; G02B 27/01

(52) U.S. Cl. CPC G02B 6/0036; G02B 5/1866; G02B 27/0172; G02B 1/11

(57) ABSTRACT

Aspects of the present disclosure provide an apparatus for improving the performance of an output coupler of a waveguide display panel, such as reducing eye glow. An example waveguide includes an anti-reflective coating. The waveguide further includes a substrate disposed above the anti-reflective coating, wherein the substrate comprises a refractive index of 1.5 to 2.7. The waveguide further includes a grating layer disposed above the substrate, the grating layer comprising an output coupler grating comprising a refractive index of 2.1 to 2.5, and a coating that covers the output coupler grating, wherein the coating comprises a refractive index of 1.5 to 1.9.

### BACKGROUND

### Field

Aspects of the present disclosure generally relate to an optical device. More specifically, embodiments described herein provide a waveguide having an improved output coupler for a display panel.

### Description of the Related Art

Virtual reality is generally considered to be a computer generated simulated environment in which a user has an apparent physical presence. A virtual reality experience can be generated in three dimensions and viewed with a head-mounted display (HMD), such as glasses or other wearable display devices that have near-eye display panels as lenses to display a virtual environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Optical devices including waveguide combiners, such as augmented reality waveguide combiners, and flat optical devices, such as metasurfaces, are used to assist in overlaying images. Generated light is propagated through an optical device until the light exits the optical device and is overlaid on the ambient environment. Optical devices may use a diffractive waveguide with surface relief gratings as an output coupler to out couple the light to a user's eye. In certain cases, the surface relief grating may allow some light to leak out from the near-eye display away from the user. Such leakage is often called eye glow. In some cases, the surface relief grating may provide differing diffraction efficiencies for certain color bands resulting in varying color intensities.

Accordingly, what is needed in the art are improved output couplers for waveguide display panels.

### SUMMARY

Some aspects provide a waveguide. The waveguide includes an anti-reflective coating. The waveguide further includes a substrate disposed above the anti-reflective coating, wherein the substrate comprises a refractive index of 1.5 to 2.7. The waveguide further includes a grating layer disposed above the substrate, the grating layer comprising an output coupler grating comprising a refractive index of 2.1 to 2.5, and a coating that covers the output coupler grating, wherein the coating comprises a refractive index of 1.5 to 1.9.

Some aspects provide a display device. The display device includes a waveguide and an optical transmitter. The waveguide includes an anti-reflective coating and a substrate disposed above the anti-reflective coating, wherein the substrate comprises a refractive index of 1.5 to 2.7. The waveguide further includes a grating layer disposed above the substrate, the grating layer comprising an output coupler grating comprising a refractive index of 2.1 to 2.5, and a coating that covers the output coupler grating, wherein the coating comprises a refractive index of 1.5 to 1.9. The optical transmitter is optically coupled to the waveguide.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and may admit to other equally effective embodiments.

FIG. 1 is a diagram illustrating an example display device using a single-waveguide waveguide.

FIG. 2 is a diagram illustrating an example waveguide having an improved output coupler structure.

FIG. 3 is a graph depicting a diffraction efficiency over grating thickness associated with the example waveguide structure described herein with respect to FIG. 2.

FIGS. 4A and 4B are graphs depicting user-to-world ratios associated with the example waveguide structure described herein with respect to FIG. 2.

FIG. 5 is a graph illustrating diffraction efficiencies for an example grating that has a coating and an example grating without a coating for different grating thicknesses.

FIG. 6 are graphs illustrating diffraction efficiencies of an example waveguide for a blue beam, a green beam, and a red beam, respectively.

FIGS. 7A and 7B are cross-sectional diagrams illustrating example waveguides having an angle etch grating and a blaze grating, respectively.

FIG. 8 is a cross-sectional diagram illustrating an example waveguide having a confocal coating.

FIGS. 9A and 9B are cross-sectional diagrams illustrating example waveguides having variable thicknesses for a refractive gradient layer, respectively.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Aspects of the present disclosure provide an apparatus for improving the performance of an output coupler of a waveguide display panel.

A surface relief grating (SRG) of a waveguide display panel, for example, used in augmented reality devices, may produce eye glow, which may be represented as a ratio of light traveling away from the user's eye and into the outside world divided by the light traveling to the user's eye. As an example, some commercially available augmented reality devices use double side binary (symmetric) gratings and others use double side imprinted slant (asymmetric) gratings for their output couplers to produce eye glow of about 40% to 60%. The light leakage associated with eye glow may cause some of the optical energy of the optical transmitter to be wasted, and as a result, the light leakage may affect the power consumption of a portable headset or glasses. In some cases, the light leakage may affect the ability of the user to socially communicate via eye contact due to the light leakage preventing others from making eye contact with the user without eye contact. In certain cases, the light leakage may prevent the content being displayed to the user from being private as others can see the content via the leakage. To reduce the eye glow impact, some commercially available waveguides shift the eye glow to a different angle by tilting the glass frame. However, the frame tiling may lead to a non-overlapped binocular field of view (FOV), in addition to not ensuring the privacy of the content.

Aspects of the present disclosure provide an output coupler for a waveguide display panel that may reduce eye glow and improve color uniformity. A single layer or multilayer anti-reflective coating may be arranged to cover a substrate with asymmetric gratings to facilitate an enhanced user-to-world ratio. In some cases, one or more layers may be arranged between a substrate and the asymmetric gratings to improve color uniformity and/or reduce eye glow. As an example, a single-layer waveguide may have a substrate arranged between an anti-reflective layer and a refractive gradient layer having a refractive index that is greater than a refractive index of the substrate. An asymmetric grating may be arranged above the refractive gradient layer, and a coating may be arranged to cover the grating. The coating may be designed to reduce the diffraction efficiency and improve the color uniformity of the output coupler.

The waveguide structure described herein may provide various advantages. For example, the waveguide structure described herein may reduce light leakage (e.g., eye glow) emitted from the waveguide. In some cases, the eye glow of the waveguide structure may be reduced to only 0.05%~10%, for example. The reduced light leakage can improve the performance of a display device due to efficient usage of the light output by an optical transmitter. In some cases, the reduced light leakage may improve the user experience by facilitating social communication via eye contact. The reduced light leakage may ensure the user's privacy in viewing content via the display panel. The waveguide structure described herein may provide improved color uniformity across multiple color bands (e.g., blue, green, and red bands). Such color uniformity of the waveguide structure may facilitate a single-layer waveguide (e.g., a waveguide configured to guide multiple color bands, such as red, blue, and green bands) with improved performance across multiple color bands.

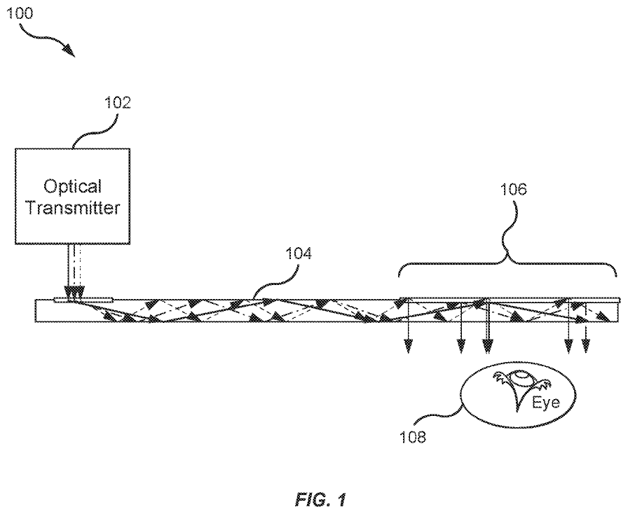

FIG. 1 is a diagram illustrating an example display device 100 using a single-layer waveguide. In this example, the display device 100 may include an optical transmitter 102 and a waveguide 104. The display device 100 may be included in an augmented reality device, such as an augmented reality headset, glasses, or a display. The optical transmitter 102 may be optically coupled to the waveguide 104. As an example, the optical transmitter 102 may include any suitable device capable of emitting electromagnetic waves in the optical spectrum, such as a light emitting diode (LED) and/or a laser. The optical transmitter 102 may output light in one or more optical spectral bands, including, for example, a blue band, a green band, and/or a red band.

The waveguide 104 may include an output coupler segment 106 that diffracts the light guided through the waveguide 104 towards a user's eye 108. As further described herein, the waveguide 104 may be configured to reduce light leakage away from the user's eye 108 (e.g., reduce eye glow) and/or improve the color uniformity (e.g., reduce rainbow effects).

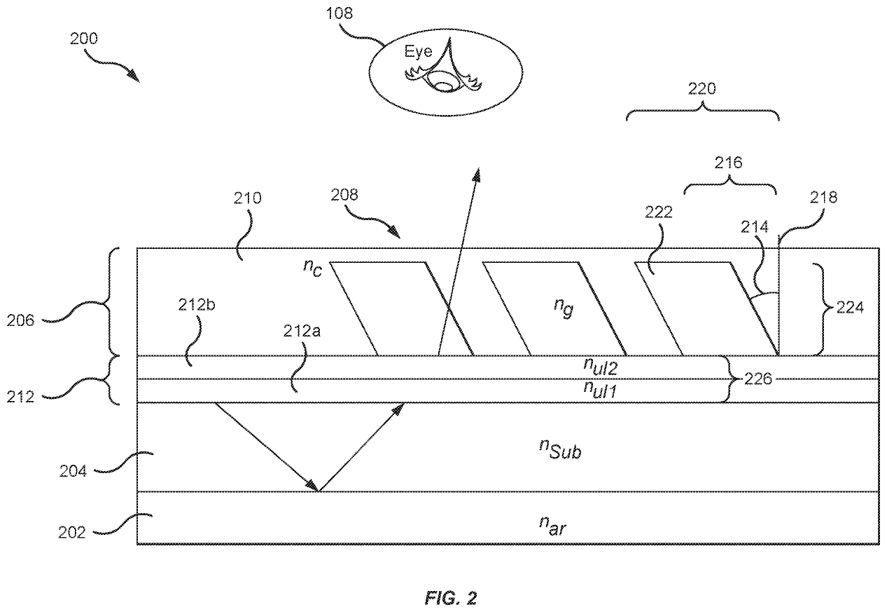

FIG. 2 is a cross-sectional diagram illustrating an example waveguide 200 having an improved output coupler structure. In this example, the waveguide 200 may be representative of a portion of the output coupler segment 106 as depicted in FIG. 1. In certain aspects, the waveguide 200 may include a single-layer waveguide configured to guide multiple bands of light, including, for example, a blue band, a green band, a red band, or a combination thereof. In some cases, the waveguide 200 may include multiple waveguide layers (not shown), for example, a first waveguide for a blue band, a second waveguide for a green band, and a third waveguide for a red band. As shown, the waveguide 200 comprises an anti-reflective coating 202, a substrate 204, and a grating layer 206. In some cases, the waveguide 200 may further include one or more refractive gradient layers 212a, 212b (collectively the refractive gradient layers 212).

The anti-reflective coating 202 may have a refractive index (nₐᵣ₁) that is less than the refractive index (n_{sub}) of the substrate 204. The anti-reflective coating 202 may enable light to be guided through the waveguide 200 via the substrate 204. For example, the anti-reflective coating 202 may cause reflections to travel through the substrate 204 as depicted in FIG. 1 and eventually through the grating layer 206 to the user's eye 108.

The substrate 204 may be disposed above the anti-reflective coating 202. In certain aspects, the substrate 204 may be or include any suitable substrate material, for example, silicon oxide (SiOₓ), silicon carbide (SiC), lithium niobater (LiNbOx), or any combination thereof. As an example, the substrate 204 may include a waveguide core material, such as glass including silica glass. The substrate 204 may have a refractive index (n_{sub}) of 1.5 to 2.7, for example. In certain aspects, the substrate 204 may include one or more sheets or layers (not shown) of waveguide material.

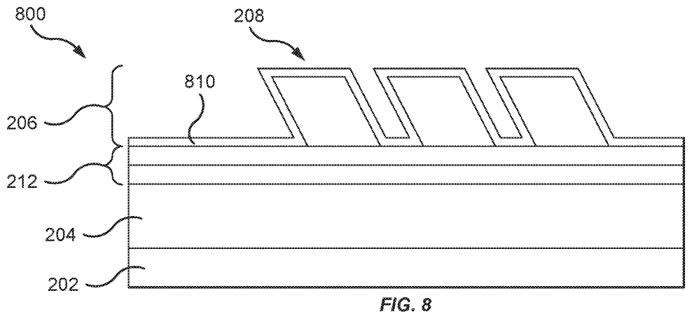

The refractive gradient layer 212 may provide a refractive gradient between the substrate 204 and the grating layer 206. The refractive gradient layer 212 may be arranged between the substrate 204 and the grating layer 206. The refractive gradient layer 212 may have a refractive index (nᵤₗ₁, nᵤₗ₂) that is greater than a refractive index (n_{sub}) of the substrate 204. In some cases, the refractive gradient layer 212 may have a refractive index of 2.1 to 2.5, for example. The refractive gradient layer 212 may have a thickness 226 of 1 nm to 200 nm. In some cases, the thickness of the refractive gradient layer 212 may have a constant thickness or a variable thickness as further described herein with respect to FIGS. 8A and 8B.

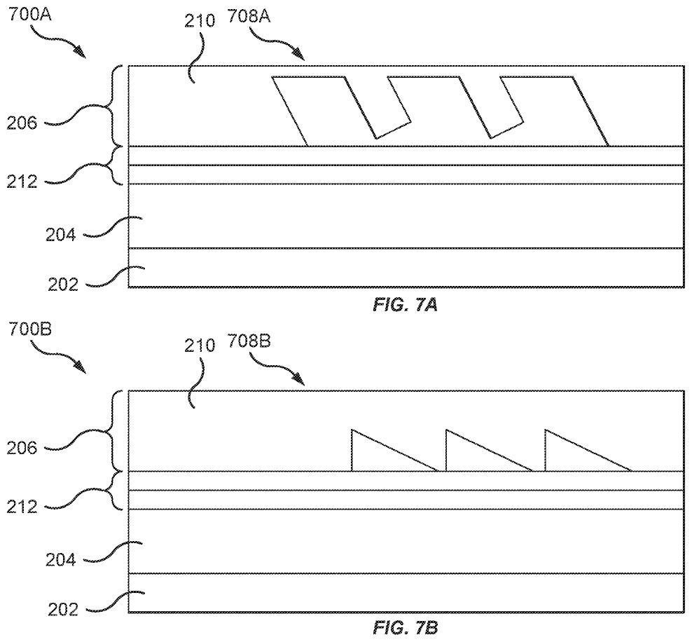

The grating layer 206 may be disposed above the substrate 204. In this example, the grating layer 206 is disposed above the refractive gradient layer 212. The grating layer 206 may include an output coupler grating 208 and a coating 210. The output coupler grating 208 may be or include an asymmetric grating, such as a slant grating with a flat bottom (e.g., as depicted in FIG. 2), a blaze grating (e.g., as depicted in FIG. 7B), a slant grating with a tilted bottom (e.g., as depicted in FIG. 7A), or a combination thereof.

The grating 208 may have at least one slant angle 214 of 40 degrees to 80 degrees and at least one duty cycle of 20% to 80% or at least one duty cycle of 40% to 70%. The slant angle 214 may be the angle between a plane 218, which may extend perpendicular from the substrate 204 and/or the refractive gradient layer 212, and a fin 222 of the grating 208. In some cases, the grating 208 may have fins 222 with varying slant angles, for example, in a range of 0 to 80 degrees, or a uniform slant angle. The duty cycle may represent the ratio of the width 216 of the fin 222 to the width 220 of the period of the grating 208. In some cases, the grating 208 may have fins 222 with varying duty cycles or a uniform duty cycle. The grating 208 may have a height (or depth) 224 of at least 20 nm to 300 nm. In certain aspects, the height 224 may vary or be uniform among the fins 222.

The output coupler grating 208 may include a noble metal, a non-noble metal, an oxide, a ceramic, a phase change material, a semiconductor, or any combination thereof, for example. The output coupler grating 208 may include amorphous silicon (aSi), silicon oxide (SiOx), silicon nitride (SiNx), titanium oxide (TiOx), tantalum oxide (TaOx), niobium oxide (NbOx), aluminum oxide (AlOx), chromium oxide (CrOx), magnesium oxide (MgOx), lithium niobater (LiNbOx), or a combination thereof. As shown, the coating 210 covers the output coupler grating 208 to enhance the user-to-world ratio and/or improve the color uniformity. In some cases, the coating 210 may include one or more coating layers (layers of coating). As an example, the coating 210 may include a photoresist material or a deposited thin film material. The coating 210 may reduce the diffraction efficiency and improve the color uniformity of the waveguide 200. The output coupler grating 208 may have a refractive index (n_{g}) that is greater than a refractive index (n_{c}) of the coating 210. As an example, the output coupler grating may have a refractive index (n_{g}) of 2.1 to 2.5, and the coating may have a refractive index (n_{c}) of 1.5 to 1.9. In some cases, with the coating 210, the transmission/reflection ratio may be increased to about 99:1, and the potential user-to-world ratio may be dramatically improved to about 50:1 or higher. The coating 210 may be arranged to have a continuous flat surface above the grating 208.

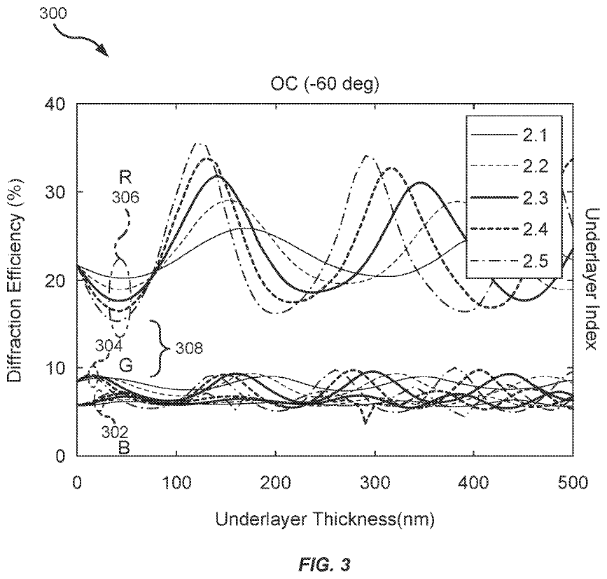

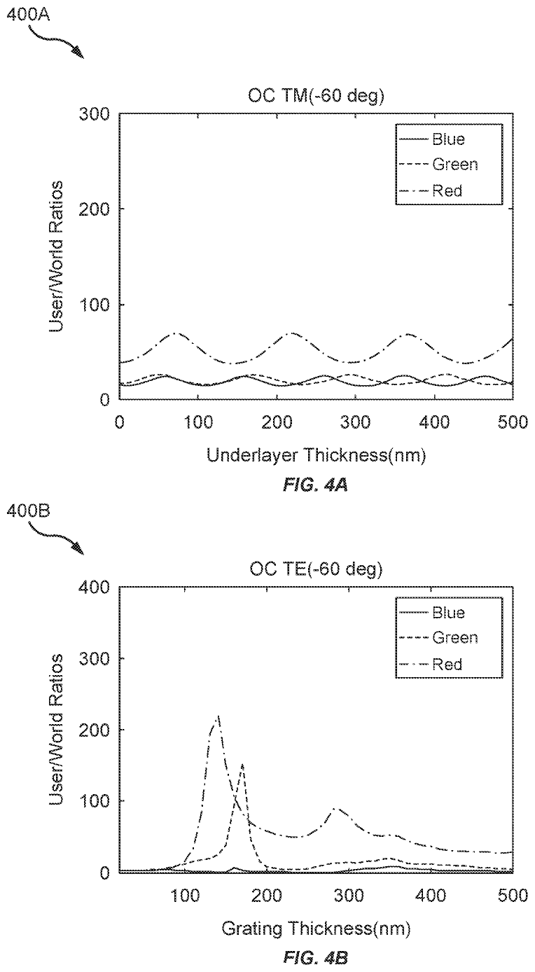

FIG. 3 is a graph 300 depicting a diffraction efficiency over grating thickness, and FIGS. 4A and 4B are graphs 400A and 400B depicting a user-to-world ratio associated with the waveguide structure described herein with respect to FIG. 2. In these examples, the grating has a slant angle of negative 60 degrees. With respect to FIG. 3, the refractive gradient layer has a refractive index and thickness that vary as depicted in the graph 300. As shown in FIG. 3, curves 302, 304, 306 represent the diffraction efficiencies associated with a blue beam, a green beam, a red beam, respectively. It will be appreciated that the graph 300 demonstrates that the waveguide structure described herein provides desirable diffraction efficiency. For example, the curves 302, 304 have intersecting diffraction efficiencies throughout the varying thicknesses, and there is an efficiency separation 308 between the curves 306 and the curves 302, 304 that is less than about 10%.

With respect to FIG. 4A, the graph 400A depicts the user-to-world ratios associated with a blue beam, a green beam, and a red beam for different thicknesses (e.g., the thickness 226) of the refractive gradient layer(s) 212 (labeled as the “underlayer”). With respect to FIG. 4B, the graph 400B depicts the user-to-world ratios associated with a blue beam, a green beam, and a red beam for different thicknesses (e.g., the height 224) of a grating. FIGS. 4A and 4B demonstrate that the user-to-world ratios may be adjusted based on the thickness of the refractive gradient layer(s) 212 and/or the grating. In certain cases, the waveguide structure described herein may enable a user-to-world ratio that exceeds fifty, and the waveguide structure described herein may facilitate beams (e.g., a green beam and a red beam or a blue beam and a green beam) that have coinciding user-to-world ratios.

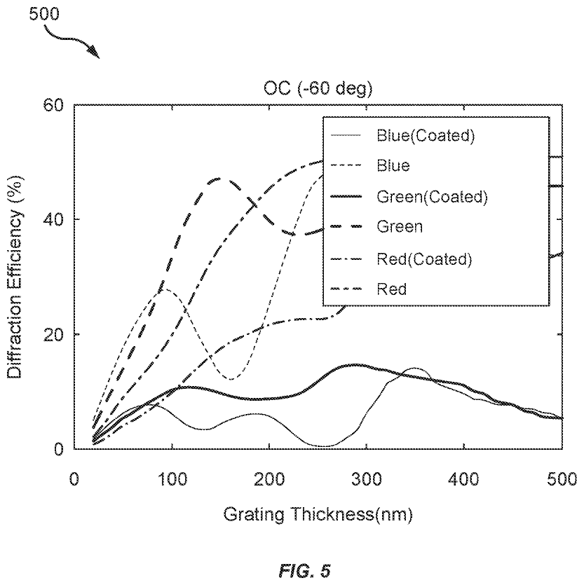

FIG. 5 is a graph 500 illustrating diffraction efficiencies for an example grating that has a coating (e.g., the coating 210) and an example grating without a coating for different grating thicknesses. As shown, the diffraction efficiencies for the example grating with the coating are reduced compared to the example grating without the coating. The reduced diffraction efficiencies may improve the color uniformity associated with the waveguide.

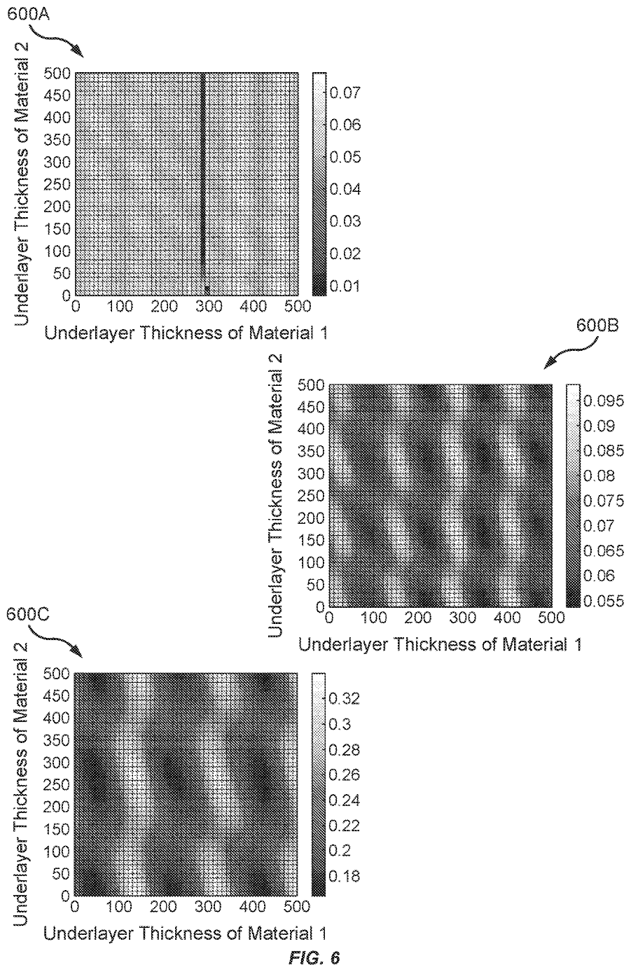

FIG. 6 are graphs 600A, 600B, and 600C illustrating diffraction efficiencies of an example waveguide for a blue beam, a green beam, and a red beam, respectively. In this example, the waveguide has a refractive gradient layer comprising a first refractive gradient layer 212a and a second refractive gradient layer 212b, for example, as depicted in FIG. 2. The x-axis corresponds to the thickness of the first refractive gradient layer 212a (e.g., having a refractive index 2.2 at a wavelength of 450 nm, 2.1 at a wavelength of 520 nm, and 2.1 at a wavelength of 620 nm), and the y-axis corresponds to the thickness of the second refractive gradient layer 212b (e.g., having a refractive index 2.7 at a wavelength of 450 nm, 2.6 at a wavelength of 520 nm, and 2.5 at a wavelength of 620 nm). The graphs 600A, 600B, and 600C demonstrate that the diffraction efficiencies may be adjusted based on the thickness of the respective refractive gradient layer(s).

FIGS. 7A and 7B are cross-sectional diagrams illustrating example waveguides 700A and 700B having an angle etch grating and a blaze grating, respectively. As shown in FIG. 7A, the grating layer 206 includes an output coupler grating 708A, which is a slant grating with a tilted bottom. The grating 708A may effectively be a slant granting with a shoulder that remains from the etching process. As depicted in FIG. 8B, the grating layer 206 includes an output coupler grating 708B, which is a blaze grating.

FIG. 8 is a cross-sectional diagram illustrating an example waveguide 800 having a confocal coating 810. In this example, the grating layer 206 may include the confocal coating 810 that covers the output coupler grating 208. The coating 810 may be arranged to cover the output coupler grating 208 to have the same or similar profile as the output coupler grating 208.

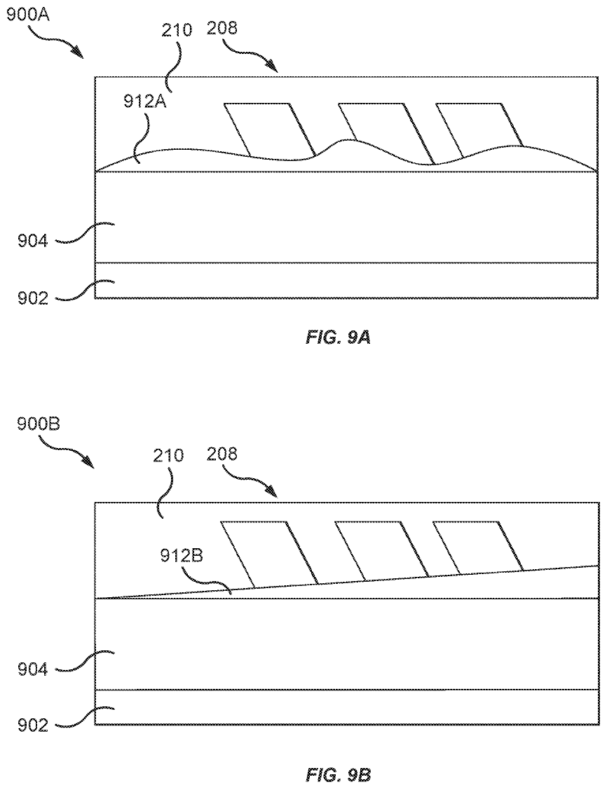

FIGS. 9A and 9B are cross-sectional diagrams illustrating example waveguides 900A and 900B having variable thicknesses for the refractive gradient layer, respectively. As shown in FIG. 9A, the refractive gradient layer 912A may have a thickness that varies. With respect to FIG. 9B, the refractive gradient layer 912B may have a thickness that gradually increases.

While the foregoing is directed to embodiments of the present disclosure, other and further embodiments of the disclosure may be devised without departing from the basic scope thereof, and the scope thereof is determined by the claims that follow.

What is claimed is:

1. A waveguide, comprising:
an anti-reflective coating;
a substrate disposed above the anti-reflective coating, wherein the substrate comprises a refractive index of 1.5 to 2.7; and
a grating layer disposed above the substrate, the grating layer comprising:
an output coupler grating comprising a refractive index of 2.1 to 2.5, and
one or more coating layers that cover the output coupler grating, wherein
the one or more coating layers comprises a refractive index of 1.5 to 1.9.

2. The waveguide of claim 1, further comprising one or more layers arranged between the substrate and the grating layer, wherein the layer has a refractive index that is greater than a refractive index of the substrate.

3. The waveguide of claim 2, wherein the one or more layers comprises a layer having a refractive index of 2.1 to 2.5.

4. The waveguide of claim 1, wherein the output coupler grating has a refractive index that is greater than a refractive index of the one or more coating layers.

5. The waveguide of claim 1, wherein the output coupler grating comprises a slant grating having a flat bottom, a blaze grating, a slant grating having a tilted bottom, or a combination thereof.

6. The waveguide of claim 1, wherein:
the output coupler grating comprises amorphous titanium oxide (aTiOx), lithium niobater (LiNbOx), or a combination thereof;
the one or more coating layers comprises a photoresist material; and
the substrate comprises glass, silicon oxide (SiOx), silicon carbide (SIC), lithium niobater (LiNbOx), or a combination thereof.

7. The waveguide of claim 1, wherein the output coupler grating comprises a slant grating having at least one slant angle of 0 degrees to 80 degrees, having at least one duty cycle of 20% to 80%, and having at least one height of 20 nm to 300 nm.

8. The waveguide of claim 1, wherein the waveguide comprises a single-layer waveguide configured to guide multiple bands of light.

9. A display device, comprising:
a waveguide comprising:
an anti-reflective coating,
a substrate disposed above the anti-reflective coating, wherein the substrate comprises a refractive index of 1.5 to 2.7,
a grating layer disposed above the substrate, the grating layer comprising:
an output coupler grating comprising a refractive index of 2.1 to 2.5, and
one or more coating layers that covers the output coupler grating, wherein the one or more coating layers comprises a refractive index of 1.5 to 1.9; and
an optical transmitter optically coupled to the waveguide.

10. The display device of claim 9, wherein the waveguide further comprises one or more layers arranged between the substrate and the grating layer, wherein the one or more layers has a refractive index that is greater than a refractive index of the substrate.

11. The display device of claim 9, wherein the output coupler grating has a refractive index that is greater than a refractive index of the one or more coating layers.

12. The display device of claim 9, wherein the output coupler grating comprises a slant grating, a blaze grating, or a combination thereof.

13. The display device of claim 9, wherein:
the output coupler grating comprises amorphous titanium oxide (aTiOx), lithium niobater (LiNbOx), or a combination thereof;
the one or more coating layers comprises a photoresist material; and
the substrate comprises glass, silicon oxide (SiOx), silicon carbide (SIC), lithium niobater (LiNbOx), or any combination thereof.

14. The display device of claim 9, wherein the output coupler grating comprises a slant grating having at least one slant angle of 0 degrees to 80 degrees, having at least one duty cycle of 20% to 80%, and having at least one height of 20 nm to 300 nm.

15. The display device of claim 9, wherein the waveguide comprises a single-layer waveguide configured to guide multiple bands of light.

16. A waveguide, comprising:
an anti-reflective coating;
a substrate disposed above the anti-reflective coating, wherein the substrate comprises a refractive index of 1.5 to 2.7;
a grating layer disposed above the substrate, the grating layer comprising:
an output coupler grating comprising a refractive index of 2.1 to 2.5; and
a refractive gradient layer arranged between the substrate and the grating layer.

17. The waveguide of claim 16, wherein the refractive gradient layer having a thickness that varies.

18. The waveguide of claim 17, wherein the refractive gradient layer comprises a refractive index that is greater than a refractive index of the substrate.

19. The waveguide of claim 17, wherein the output coupler grating has a refractive index that is greater than a refractive index of the refractive gradient layer.

20. The waveguide of claim 17, wherein the output coupler grating comprises a slant grating having at least one slant angle of 0 degrees to 80 degrees, having at least one duty cycle of 20% to 80%, and having at least one height of 20 nm to 300 nm.
